(19) United States
(12) Patent Application Publication
(10) Pub. No.: US 2008/0059886 A1
(43) Pub. Date: Mar. 6, 2008

(54) Smart picture selector and cache

(75) Inventor: Mark S. Grossman, Palo Alto, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ATI Technologies Inc., Markham (CA)

(21) Appl. No.: 11/513,189

(22) Filed: Aug. 31, 2006

(51) Int. Cl. G06F 3/00; G06F 9/00

(52) U.S. Cl. 715/733; 715/810; 715/835; 715/838

(57) ABSTRACT

A method for intelligently selecting a display image in a networked device is described. The method comprises receiving from a content provider image information and corresponding media data for display on a device. From the received image information, an image selection policy is determined. The image selection policy includes a level of specificity for an image to be to be displayed with the corresponding media data. An image for display is then selected for the corresponding text based on the determined image selection policy. The selected image is chosen from either (i) the memory cache of previously received images, or (ii) from the content provider.

### BACKGROUND OF THE INVENTION

1. Field of the Invention

The invention relates generally to the field of networked devices such as handheld computers, cell phones or personal computers that are used to receive and view downloadable content from a content provider. In particular, the invention relates to a system and method for selecting and caching relevant image content for a display device.

2. Background

Networked devices such as handheld computers and cell phones are increasingly used for downloading content from the World Wide Web via an internet connection such as a wireless internet connection. Image data, in contrast to text data, typically consumes a large portion of the memory for downloadable content. While such networked devices often have limited bandwidth, they nonetheless typically have adequate and ever increasing amounts of processing power and storage. As such, there may be a bandwidth bottleneck when it comes to downloading image data for content such as illustrated news feeds. Such a bandwidth bottleneck can even occur in a personal computer operating with, for example, dial-up or wireless internet access.

There is thus a need for improved processes and systems that can potentially alleviate the bandwidth bottleneck that potentially occurs when downloading image data. It would be beneficial for improvements to allow for both user and content provider control over downloaded and displayed image data. It would also be beneficial for improvements to take advantage of currently implemented communication protocols and available technology.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary system in which the described embodiments may operate.

FIG. 2 illustrates an exemplary networked device.

FIG. 3 illustrates a general image selection method.

FIG. 4 illustrates a more detailed image selection method.

FIG. 5 illustrates an exemplary caching method.

FIG. 6 illustrates computer system in which embodiments of the invention may operate.

The present invention will now be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

### Introduction

Networked devices such as handheld computers and cell phones have increasing processing power and available memory. However, many are still bandwidth limited with respect to receiving downloadable content from the World Wide Web, especially considering the visually rich array of available image content. Device designers continually seek ways to improve the visual quality of the display environment without further taxing the available bandwidth. Described herein is a system and method that accomplishes this goal by leveraging the memory and processing power available in networked devices to intelligently and flexibly control the image data to be displayed on the device.

### Exemplary Environment

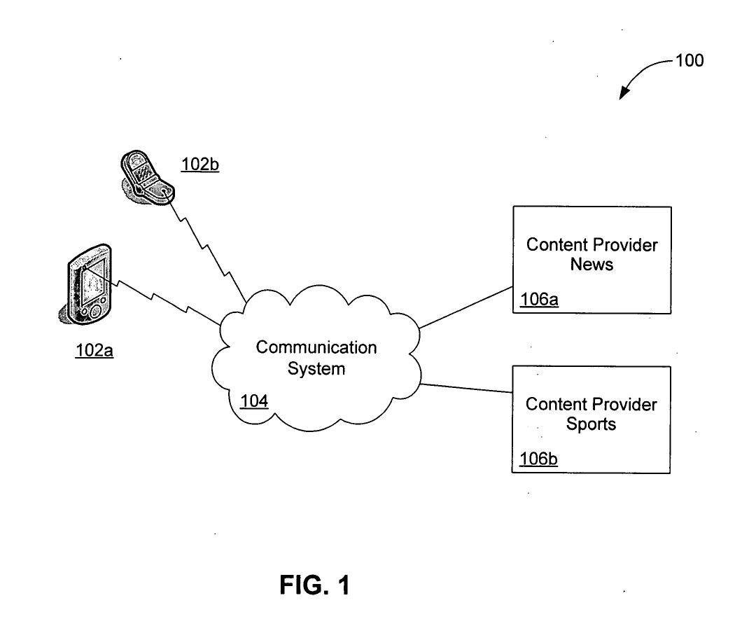

Before describing embodiments of the present invention in detail, it is helpful to describe an exemplary environment in which the claimed system and methods may be implemented. FIG. 1 illustrates a networked system 100. The system may include a plurality of content receiving devices such as handheld computer 102a or a cellular phone 102b, a communication system 104 such as a wireless internet access point and associated network, and a plurality of content providers that provide items such as news 106a or sports 106b information.

The described system 100 is merely exemplary and could include additional content receiving devices such as a mobile or desktop computer, or other wired or wireless networked systems. System 100 could also include additional content providers such as a directory assistance provider, media feeds from a financial service provider with up-to-date financial news, podcasts, audio clips, streaming graphics data, and the like. The provided content is not limited in form or function except that improvements are most notable where media information or data is desired to be displayed with corresponding image data and there is some flexibility in determining the image to be displayed. Similarly, the image data is not limited in form or function and may include pictures, textures, or other graphical data. System 100 could also include an alternate communication system, including a wired communication system or hybrid wired and wireless system.

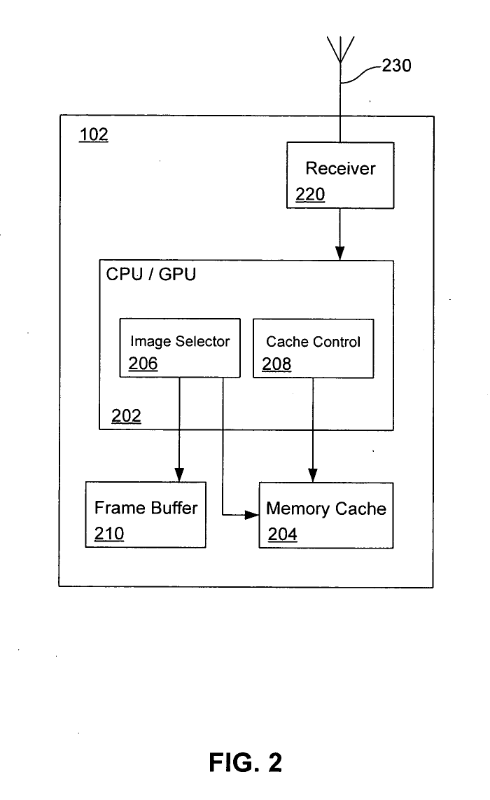

FIG. 2 illustrates an exemplary content receiving display device 102. The content receiving display device 102 includes an antenna 230 coupled to a receiver 220. The antenna 230 and receiver 230 act together to receive downloadable content from content provider 106 via communication system 104. There are many known examples for achieving this functionality and the claims are not limited to the wireless example illustrated in FIG. 2. For example, device 102 could also receive content via a wired connection (not shown) or from another networked device using, for example, an infra-red data communication system.

The receiver 220 is coupled to a central processing unit and/or a graphics processing unit 202. Again, the state of the art includes many such processing units. The central processing unit 202 includes or executes an image selector module 206 and a cache control module 208. Their functionality may be implemented in software, hardware, firmware or any combination thereof. The function of these modules is explained more fully below.

The image selector module 206 communicates with a frame buffer 210 and to a memory cache 204. As explained more fully below, the image selector module 206 is responsible for selecting an appropriate image to be displayed on device 102 with corresponding text received from content provider 106. The cache control module 208 communicates with a cache memory 204. As explained more fully below, the cache control module 208 is responsible for determining whether to cache a selected image in the cache memory 204 for possible reuse. The frame buffer 210 is a temporary memory device that stores the next frame of content to be displayed. The frame buffer 210 and memory cache 204 may be physically combined, but logically separate sections of memory, or may be physically and logically separate as well. The frame buffer 210 is coupled to a display (not shown). The display is typically a liquid crystal display (LCD) capable of displaying image data and corresponding text.

The above described system 100 and display device 102 make up an exemplary environment in which the below described embodiments operate. One skilled in the art could easily envision and implement alternate environments. Briefly, however, a method and system are described that reuse relevant images by use of a memory cache and an intelligent image selection and caching system. Content creators and providers can retain control of the presentation to varying degrees, as can the user or consumer. The quality and relevance of images can be manipulated in exchange for better performance—e.g., more efficient use of bandwidth and faster display times with minimal decrease in visual experience quality.

### Exemplary Display Image Selection Method

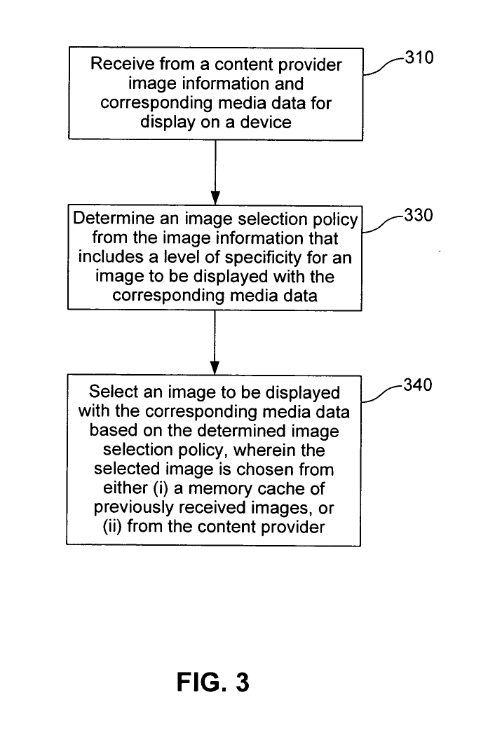

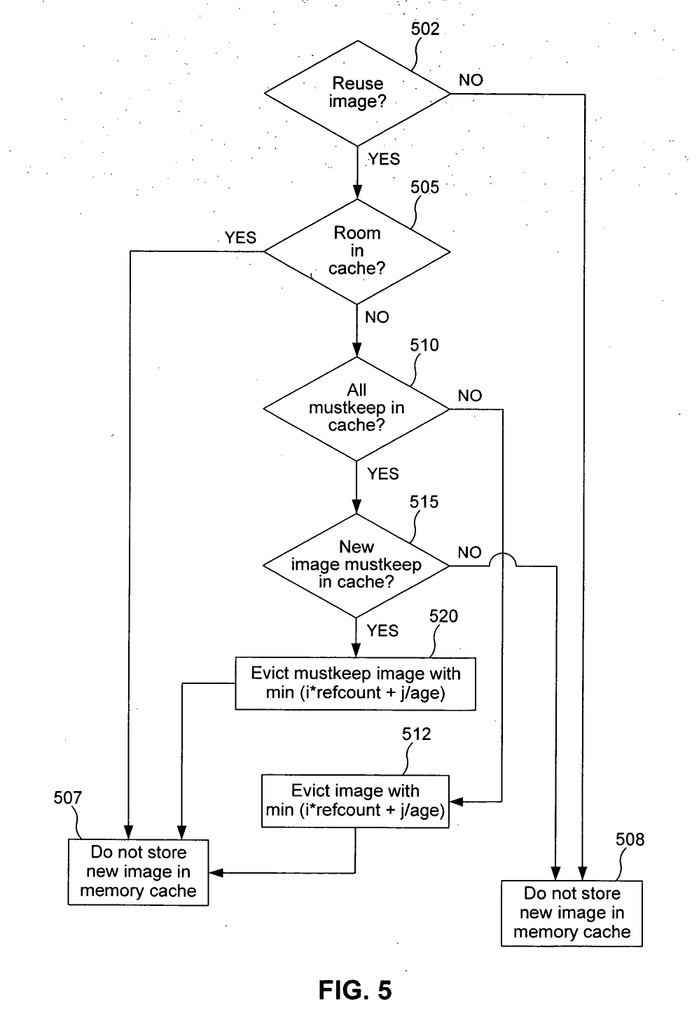

FIG. 3 illustrates an exemplary method for selecting a display image. According to step 310, a display device receives image information and corresponding text for display from a content provider. Additionally, according to step 320, a memory cache with previously received images is maintained on the device. A more detailed description of an exemplary caching policy is provided below in conjunction with FIG. 5.

With respect to image information, web-based applications typically present icons or image placeholders that include various image information for the images that are to be displayed with corresponding media data. The image information usually indicates a file type (e.g., JPEG, TIFF, etc.) and includes a uniform resource locator (URL) indicating where the image is located. Alternately, the image data could be texture data that is to be applied to graphics based media data, such as in a internet based video game. Additional information included in the image data could indicate the digital content creator, such as the name of the photographer or digital graphics designer, and the expected number of memory bytes the image will use. Digital content creation tools may also provide a library of images to attach to the media content based on a keyword search. Examples of image information are provided in more detail below.

The corresponding media data is information for an end user and can be raw text such as ASCII encoded text, formatted text such at RTF, audio information, imaged text such as JPEG, and graphics data such as instruction for rendering textured shaded geometric models. One skilled in the art will recognize, however, that the most benefit is derived where the corresponding media information is smaller in memory size than the (cached) images for a particular presentation.

To implement the method, the image information includes information that is added by the content provider so that, according to step 330, an image selection policy may be determined from the image information. As described more fully below, an image selection policy may be delineated from the image information using Extensible Markup Language (XML) meta-data and XML based languages such as Really Simple Syndication (RSS).

With respect to the image selection policy, the image information may also indicate, for example, a level of specificity for an image. A level of specificity indicates the degree to which the content provider desires that the displayed image match the image information. For instance, the level of specificity may be “strict,” which would indicate that the content provider desires the displayed image match precisely the image identified in the image information. Alternatively, the level of specificity may be “flexible,” which indicates that the precise image need not be displayed, and a substitute image may be selected, where appropriate.

In addition to the level of specificity for the image, the content provider may include additional information in the transmitted image information. For instance, the content provider may indicate that the image is not allowed to be reused. Such a decision may be necessary to comply with a digital rights management (DRM) scheme where the content provider or creator is compensated based on the number of times the image is downloaded. The image information may also include an indication of image relevance—i.e., the likelihood that the image will be reused. This additional image information is used in the intelligent caching method described below in conjunction with FIG. 5.

Finally, according to step 340, an image for display is selected based on the determined image selection policy. The image is chosen from either (i) the memory cache of previously received images, or (ii) from the content provider. For example, the received content may be a sports story about Tiger Woods winning the 2006 British Open. The content provider may indicate a “strict” specificity for the image and desire that the exact image to be displayed is Tiger Woods kissing the Claret Jug on the 18th green at Royal Liverpool, and no other. In this case, if that particular image were already in the memory cache, it would be selected; if not, then that particular image would be downloaded from the content provider at the specified URL.

Alternatively, the content provider may indicate a flexible specificity. In this case, a set of rules is developed whereby a generic photograph of Tiger Woods could be selected from the memory cache (if available). To implement the rules, the image information and corresponding media data are analyzed. An appropriate image could be determined from, for example, the meta data accompanying the image placeholder. Alternatively, an appropriate image could be determined from parsing the actual media data feed itself—e.g., the text that will accompany the selected image or the closed captioned portion of an audio feed—and searching for relevant keywords such a proper names, place names, etc.

In an alternate embodiment, searchable keywords in the corresponding text can be used to create new image content from the cache. For example, the generic photograph of Tiger Woods could be coupled with another generic photograph of putting green. In sum, when the content provider indicates a flexible or unspecified level of specificity, images in the memory cache can be intelligently reused with little degradation in the visual experience noticed by the user. Such intelligent image selection and caching result in less consumption of bandwidth, thereby reducing the possibility of memory bottlenecks when downloading content from the internet.

In further embodiments, metadata such as subject or keywords, as well as usage tags, could be added to texture data for rendering computer graphics images. For instance, decals applied to race cars in a video game could be advantageously cached and reused according to the claimed methods. Alternatively, the claimed methods could be applied to audio data where the audio data is close captioned, or is analyzed via known speech-to-text algorithms. Relevant images could be selected from such image information derived from or included with the audio data.

The image information—e.g., the icon or image placeholder—typically has no context or instructions other than a subject and a URL where the picture, texture, or graphics data may be found, if not already stored in the memory cache. To effectively implement the above described image selection method and caching method, richer image information is embedded within the image icon or placeholder. It would be beneficial if the described system and methods implemented currently available communication protocols and formats. One such exemplary embodiment implements XML metadata using RSS semantics. The skilled artisan, however, will recognize that other protocols may be used without departing from the spirit or scope of the claimed invention.

### XML Background

To facilitate the sharing of data (or content) across different systems, particularly systems connected via the Internet, a common language has been developed called Extensible Markup Language (XML). XML provides a text-based means to describe and apply a tree-based structure to information. At its base level, all information manifests as text, interspersed with markup that indicates the information's separation into a hierarchy of character data, container-like elements, and attributes of those elements. The fundamental unit in XML is the character, as defined by the Universal Character Set. Characters are combined in certain allowable combinations to form an XML document. The document consists of one or more entities, each of which is typically some portion of the document's characters, encoded as a series of bits and stored in a text file.

As the type of data available over the Internet proliferated, so did other data description languages that are based on XML. Examples include Resource Description Framework (RDF/XML), Really Simple Syndication (RSS), Math Markup Language (MathML), Extensible HyperText Markup Language (xHTML), Scalable Vector Graphics (SVG) and even MusicXML. These languages are defined in a formal way and allow programs to modify and validate documents in these languages without prior knowledge of their precise form.

By leaving the names, allowable hierarchy, and meanings of the elements and attributes open and definable by a customizable schema, XML provides a syntactic foundation for the creation of custom, XML-based markup languages such as those noted above. The general syntax of such languages is rigid—documents must adhere to the general rules of XML, assuring that all XML-aware software can at least read parse) and understand the relative arrangement of information within them.

The schema merely supplements the syntax rules with a set of constraints. Schemas typically restrict element and attribute names and their allowable containment hierarchies. For example, an image selection policy element named “isp” may contain three different image “usage” elements describing (i) a level of specificity—e.g., ‘flexible’ or ‘strict’; (ii) an image reuse policy—e.g., ‘reuse’ or ‘none’; and (iii) a relevance indicator—e.g., ‘general’ (hi), ‘topic’ (med), ‘unique’ (low), or ‘mustkeep.’ Each can be restricted to contain only character data. The constraints in a schema may also include data type assignments that affect how information is processed. For example, image information for Tiger Woods may look like this using xHTML:

<img src=“tiger_woods.jpg” alt=”tiger_woods”>
<isp:usage>flexible reuse general</isp:usage>
<dc:subject>Tiger Woods golfer</dc:subject>
</img>

Here, the image to be displayed with the corresponding data is a JPEG image of Tiger Woods. The image selection policy, specified in the isp:usage element, indicates that level of specificity is “flexible,” that the image is allowed to be reused, and that it has a hi “general” relevance, indicating that it is likely that the image will be used again. The Dublin Core metadata standard subject element provides keywords that can be used to look up the image for reuse. As noted above, this image of Tiger Woods would be a likely image for caching.

### RSS Background

RSS is a family of XML file formats for Web syndication used by (amongst other things) news websites and weblogs. The technology of RSS allows Internet users to subscribe to websites that have provided RSS feeds; these are typically sites that change or add content regularly.

To use this technology, site owners create or obtain specialized software (such as a content management system) which, in the machine-readable XML format, presents new articles in a list, giving a line or two of each article and a link to the full article or post. Unlike subscriptions to many printed newspapers and magazines, most RSS subscriptions are free. The RSS formats provide web content or summaries of web content together with links to the full versions of the content, and other meta-data. The content often includes both image information and corresponding data. This information is delivered as an XML file called an RSS feed, webfeed, RSS stream, or RSS channel. In addition to facilitating syndication, RSS allows a website's frequent readers to track updates on the site using an aggregator.

RSS is widely used by the weblog community to share the latest entries' headlines or their full text, and even attached multimedia files. (See podcasting, vodcasting, broadcatching, photocasting, picturecasting, screencasting, Vloging, and MP3 blogs.) In mid 2000, use of RSS spread to many major news organizations, including Reuters, CNN, and the BBC, until under various usage agreements, providers allow other websites to incorporate their “syndicated” headline or headline-and-short-summary feeds. RSS is now used for many purposes, including marketing, bug-reports, or any other activity involving periodic updates or publications.

There are several known programs that can check RSS-enabled webpages on behalf of a user and display any updated articles that it finds. It is now common to find RSS feeds on major Web sites, as well as many smaller ones. Client-side readers and aggregators are typically constructed as standalone programs or extensions to existing programs like web browsers. Such programs are available for various operating systems. Web-based feed readers and news aggregators require no software installation and make the user's “feeds” available on any computer with Web access. Some aggregators syndicate (combine) RSS feeds into new feeds, e.g., take all football related items from several sports feeds and provide a new football feed.

A syntax for an image in a RSS 2.0 news feed item is illustrated below:

```
<rss version=“2.0”
xmlns:dc=“http://purl.org/dc/elements/1.1/”>
  <channel>
    <title>Top Stories</title>
    <link>http://www.your-news.com/</link>
    <description>Today's top stories updated every five
minutes.</description>
    <language>en-us</language>
    <item>
      <title>Tiger Woods Wins Open Championship</title>
      <link>http://www.your-
news.com/2007/7/23/BritishOpen.html</link>
      <description>Today in Liverpool, Tiger Woods took
home the Claret Jug.</description>
      <dc:creator>Will Person</dc:creator>
      <enclosure url=“http://www.pictures.com/Tiger-
Woods.jpg” length=“12210” type=“image/jpeg” />
    </item>
  </channel>
</rss>
```

An expanded syntax might include the following enhanced image element:

```
    <enclosure url=“http://pubpix.org/Tiger-Woods.jpg”
length=“12210” type=“image/jpeg”>
<isp:usage>flexible reuse general</isp:usage>
<dc:subject>Tiger Woods golf Claret Jug Liverpool</dc:subject>
    </enclosure>
```

The above described xHTML image information may be included in the RSS feed and an image selection policy may be derived therefrom.

### Exemplary Detailed Image Selection Algorithm

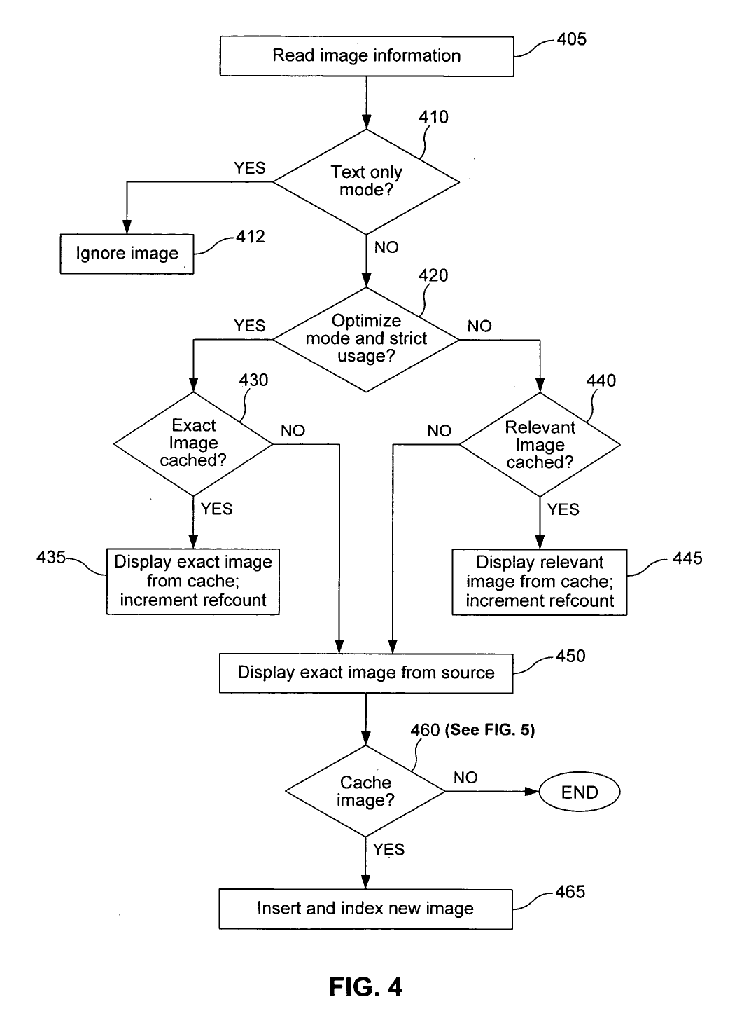

FIG. 4 illustrates in more detail an embodiment of an image selection algorithm. The method begins by reading image information according to step 405. As noted above, the image information may contain embedded information pertaining to an image selection policy along with other metadata identifying the image. Before beginning the image selection process, however, the algorithm in step 410 checks to see whether the user or the display device is in a text-only mode. A text-only mode may have been chosen by the user; or the device simply may not support image data. In any event, if the display device is in text-only mode, then the image will be ignored according to step 412. If the display device is not in text-only mode, then it may be in an “optimize” mode wherein it is able to take advantage of the disclosed methods.

If the display device is not in text-only mode, then it must be determined whether the display device should immediately use the exact image indicated in the image information. There are two such conditions. First, if the image information indicates an image selection policy with a “strict” level of specificity, and second, if the device cannot currently implement the algorithm—e.g., the “optimize mode” in which the method is implemented is unavailable or disabled. In either of these two cases, the algorithm first determines whether the exact image is cached, according to step 430. If it is, then the exact image is displayed from the memory cache according to step 435; if it is not, then the exact image is displayed from the source—e.g., the content provider—in accordance with step 450. In either case, the exact image is displayed due to the “strict” level of specificity.

If the optimize mode is available and enabled, and the image information indicates an image selection policy with a level of specificity that is “flexible” or unspecified, then it must be determined whether a relevant image exists in the memory cache of previously received images, according to step 440. If a relevant image is not available, then the exact image is displayed from the source—e.g., the content provider—in accordance with step 450. If a relevant image is available, then that relevant image is displayed from the memory cache according to step 445.

As noted above, in both of steps 435 and 445, an image is displayed from the memory cache of previously received images. Whenever an image is displayed from the memory cache according to these steps, a reference counter (refcount) is incremented for the displayed image. As explained more fully below, the refcount for an image is useful when implementing the caching policy.

If the selected image was downloaded from the source, then, a determination is made on whether to cache the new image, according to step 460. If the new image is to be cached, then it is inserted into the memory cache and indexed. If not, then the algorithm ends. The caching decision is described more fully below, in conjunction with FIG. 5.

### Exemplary Intelligent Caching Method

To effectively implement the above described image selection method, an intelligent caching policy is desirable. Proper selection and maintenance of images in the memory cache serves at least two purposes. First, it makes it more likely that a relevant image may be found in the memory cache, thus avoiding the necessity for downloading an image from the source. Second, having a rich and relevant selection of images such as pictures, textures and other graphical data in the memory cache will result in a more positive viewing experience of a user.

The caching policy should therefore be able determine from the image information the relevance of the image—i.e., the likelihood that an image should be reused. For example, if the content provider is a world news agency, then images of world leaders would have a high (general) relevance as they would be likely reused on a regular basis. Conversely, an image of a particular non-repeating event may have a low (topic specific) relevance. Additionally, the relevance of a particular image could change over time. While the event remains reportable news, images thereof may have high relevance, but as the event ends, the frequency of use of the image could fall dramatically, giving it a low relevance.

An exemplary intelligent caching policy is described in FIG. 5. Once a decision is made to download a new image from the source instead of using a previously received image from the memory cache (see above), the image information is evaluated in conjunction with the current status of the cached images to determine whether the new image should be inserted in the memory cache. As noted above, the image information may include indications of whether the content provider allows the new image to be reused as well as the new image's potential relevance. Based on this information, intelligent caching decisions may be made. It should be clear, however, that the method described below is only exemplary and a skilled programmer could envision alternate methods and procedures for selecting relevant images to cache.

First, according to step 502, it must be determined whether the content provider will allow reuse of the image. It is conceivable that the content provider may not want premium content to be reused according to their digital rights management (DRM) scheme. This is especially true if the content provider or content creator is being compensated based on how many times that particular image is downloaded. In this case, according to step 502, the downloaded image would not be cached, according to step 508. If, however, the image information indicates an image selection policy that allows for reuse of the image, then the new image may potentially be stored in the memory cache.

Next, according to step 505, it must be determined whether there is room in the memory cache. If there is room in the memory cache, then the new image is indexed and inserted in the cache, according to step 507. If there is no room in the memory cache for the new image, then further decisions must be made.

Next, if there is no room in the memory cache, the relevance of the previously received images currently stored in the memory cache are examined to determine the best candidate for eviction, according to step 510. In particular, the algorithm determines whether all of the images in the memory cache are “mustkeep” images. If they are not, the image least likely to be reused is evicted, and the new image is indexed and cached.

The image least likely to be reused is determined in step 512. As noted above, each image stored in the cache is indexed. When that image is selected for display, a reference counter (refcount) for that image is incremented. To determine the likelihood of reuse, a number (i) representing the image relevance is multiplied by the refcount. Added to this number is a variable (j) divided by the image's age, in days. The total number reflects the likelihood that the image will be reused; an image with a high number is more likely to be reused than an image with a low number.

For instance, a newer image with ‘general’ relevance that has been selected for display a number of times will have a total higher number than an older image of ‘unique’ relevance that has not been selected for display. Obviously, images with ‘mustkeep’ are not examined in this step. Therefore, according to step 512, the image with the minimum (i*refcount+j/age) is evicted from the memory cache. The above described method for determining likelihood of reuse is merely exemplary. One skilled in the art could envision modifications or other formulas that provide a similar result without departing from the spirit and scope of the method.

If all the previously received images in the memory cache have a “mustkeep” relevance, then, according to step 515, it must be determined whether the new image also has a “mustkeep” relevance. If it does not, then the new image is discarded and not cached, according to step 508. According to 520, if all the previously received images in the memory cache have a ‘mustkeep’ relevance, and the new image also has a ‘mustkeep’ relevance, then the ‘mustkeep’ image in the cache that is least likely to be reused must be identified and evicted. To determine the image to be evicted, the method described above for step 512 is repeated for the ‘mustkeep’ images in the cache.

### Example Computer System Implementation

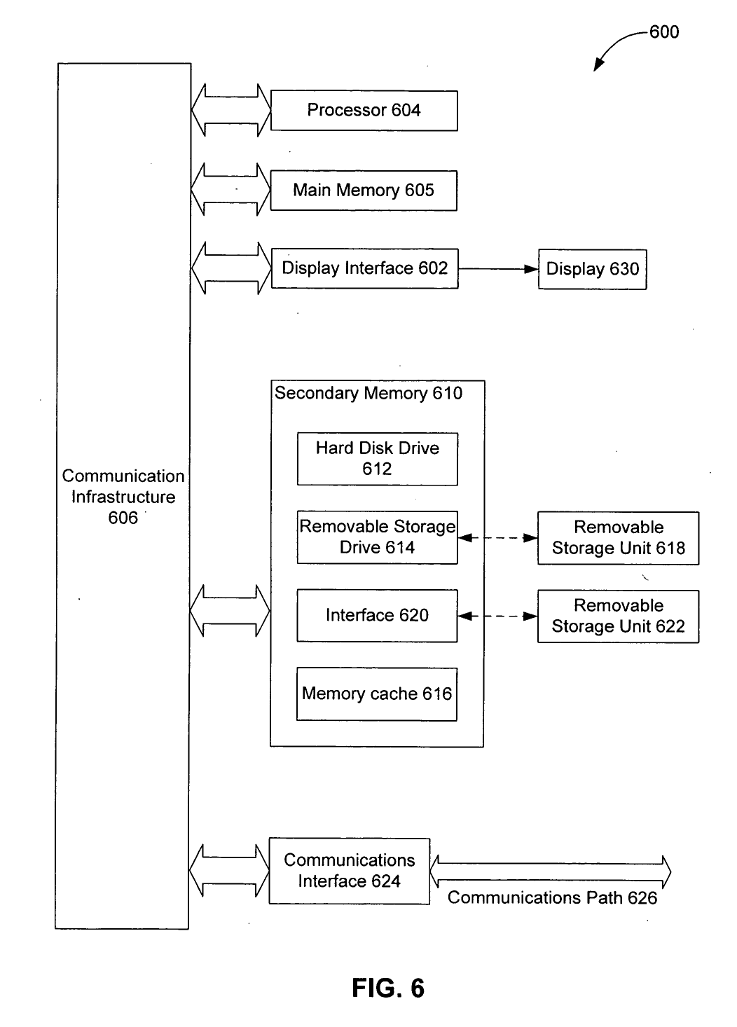

Various aspects of the present invention can be implemented by software, firmware, hardware, or a combination thereof. FIG. 6 illustrates an example computer system 600 in which the present invention, or portions thereof, can be implemented as computer-readable code. For example, the method illustrated by flowcharts of FIGS. 4 and 5 can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose processor like a graphic processing unit (GPU) or a general purpose central processing unit (CPU). Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612 and/or a removable storage drive 614, and a memory cache 616.

Removable storage drive 614 may comprise a floppy disk drive, a magnetic tape drive, an optical disk drive, a flash memory, or the like. The removable storage drive 614 reads from and/or writes to a removable storage unit 618 in a well known manner. As will be appreciated by persons skilled in the relevant art(s), removable storage unit 618 includes a computer usable storage medium having stored therein computer software and/or data. In an embodiment, the secondary memory 610 could be dedicated graphics memory for storing images and associated image information, texture data and the like. For example, a portion of the secondary memory 610 such as memory cache 616 could be used for storing previously received images and image information from a content provider.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, a hard disk installed in hard disk drive 612, and signals carried over communications path 626. Computer program medium and computer usable medium can also refer to memories, such as main memory 608 and secondary memory 610, which can be memory semiconductors (e.g., DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the method illustrated by flowcharts of FIGS. 4 and 5 discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of selecting a display image, comprising:
receiving from a content provider image information and corresponding media data for display on a device;
determining an image selection policy from the image information that includes a level of specificity for an image to be displayed with the corresponding media data; and
selecting the image to be displayed with the corresponding media data based on the determined image selection policy wherein the selected image is chosen from either (i) a memory cache of previously received images, or (ii) the content provider.

2. The method of claim 1, wherein the selected image to be displayed is composed from a plurality of images in the memory cache.

3. The method of claim 1, further comprising:
determining a caching policy for the selected image to be displayed;
selectively caching the selected image based on the determined caching policy; and
selectively evicting images from the cache that are not to be reused.

4. The method of claim 3, wherein determining the caching policy includes determining (i) whether the selected image may be reused, and (ii) whether the selected image is likely to be reused.

5. The method of claim 1, wherein if the image selection policy indicates a strict specificity level, then selecting an exactly specified image from the memory cache; or if the exactly specified image is not available in the memory cache, then retrieving the exactly specified image from the content provider and optionally caching the retrieved image.

6. The method of claim 1, wherein if the image selection policy indicates an unspecified or flexible specificity level, then selecting a relevant image from the memory cache based on an analysis of the image information and/or the corresponding media data; or if a relevant image is not available in the memory cache, then retrieving an image from the content provider based on the image information and optionally caching the retrieved image.

7. The method of claim 1, wherein determining the image selection policy from the image information further comprises identifying content provider specific rules, whereby the content provider may ensure compliance with a digital rights management scheme.

8. The method of claim 1, wherein determining the image selection policy from the image information further comprises identifying device specific rules, whereby a device user can control image selection parameters.

9. The method of claim 1, further comprising determining the image selection policy using extensible markup language (XML).

10. The method of claim 9, further comprising determining the image selection policy using XML based metadata.

11. The method of claim 1, further comprising receiving content to be displayed from a web-based media feed.

12. The method of claim 1, wherein the media data is text based data.

13. The method of claim 1, wherein the media data is audio data.

14. The method of claim 1, wherein the media data is graphics data.

15. The method of claim 14, wherein the graphics data is texture data.

16. A method for selecting a display image, comprising:
responsive to determining an image selection policy from image information accompanying corresponding media data, selecting an image to be displayed from one of (i) a memory cache of previously cached images, or (ii) a content provider, wherein the image is selected based on the image selection policy.

17. The method of claim 16, wherein the image selection policy includes a level of specificity for the image to be displayed with the corresponding media data.

18. The method of claim 17, wherein if the image selection policy indicates a strict specificity level, then selecting an exactly specified image from the memory cache, if available; or if the exactly specified image is not available in the memory cache, then retrieving the exactly specified image from the content provider and optionally caching the retrieved image.

19. The method of claim 17, wherein if the image selection policy indicates an unspecified or flexible specificity level, then selecting a relevant image from the memory cache based on an analysis of the image information and/or the corresponding media data; or if a relevant image is not available in the memory cache, then retrieving an image from the content provider based on the image information and optionally caching the retrieved image.

20. One or more computer-readable media having computer-executable instructions thereon that, when executed by a computer, perform a method comprising the acts of: responsive to determining an image selection policy from image information accompanying corresponding media data, selecting an image to be displayed from one of (i) a memory cache of previously cached images, or (ii) a content provider, wherein the image is selected based on the image selection policy.

21. A computer system for selecting a display image, comprising:
a processor;
a communications interface coupled to the processor for receiving image information and corresponding media data from a content provider;
means for determining an image selection policy from the received image information that includes a level of specificity for an image to be displayed with the corresponding media data; and
means for selecting an image to be displayed with the corresponding media data based on the determined image selection policy, wherein the selected image is chosen from either (i) the memory cache of previously received images, or (ii) from the content provider.
